(19) United States
(12) Patent Application Publication
(10) Pub. No.: US 2013/0251906 A1
(43) Pub. Date: Sep. 26, 2013

(54) RECORDING MEDIUM, IMPRINT METHOD, AND IMPRINT APPARATUS

(71) Applicant: Michiya TAKIMOTO, Mie (JP)

(72) Inventor: Michiya TAKIMOTO, Mie (JP)

(73) Assignee: Kabushiki Kaisha Toshiba, Tokyo (JP)

(21) Appl. No.: 13/597,835

(22) Filed: Aug. 29, 2012

(30) Foreign Application Priority Data
Mar. 21, 2012 (JP) 2012-064145

(51) Int. Cl. B05D 3/12; B05C 11/10

(52) U.S. Cl. 427/277; 118/696

(57) ABSTRACT

According to an embodiment, a non-transitory computer readable recording medium that records a dropping position setting program is provided. The dropping position setting program causes a computer to execute extracting a large pattern region whose pattern size is larger than a preset reference value from a template pattern used for imprinting and setting a first dropping position within a predetermined range from a position of the large pattern region and a second dropping position in a region other than the first dropping position as a dropping position of resist to be dropped in an imprint shot on a processing target substrate.

### CROSS-REFERENCE TO RELATED APPLICATIONS

This application is based upon and claims the benefit of priority from Japanese Patent Application No. 2012-064145, filed on Mar. 21, 2012; the entire contents of which are incorporated herein by reference.

### FIELD

An embodiment described herein relates generally to a recording medium, an imprint method, and an imprint apparatus.

### BACKGROUND

Recently, an imprint method of transferring a mold (template) of a master onto a substrate attracts attention. In the imprint method, a template pattern is filled with resist by pressing a template on which a pattern that needs to be transferred is formed against a photocurable organic material layer (resist) applied to the substrate. Then, in a state where the template pattern is filled with the resist, the resist is irradiated with light to cure the resist, thereby transferring the pattern onto the resist.

In such an imprint method, when the template pattern is not sufficiently filled with the resist, pattern defects occur. In order to eliminate the pattern defects due to insufficient filling, it is needed to wait until the template pattern is completely filled with the resist by increasing the holding time (filling time) before the template is irradiated with light after the template is brought into contact with the resist.

However, if the filling time of the resist is increased, throughput is reduced. Therefore, a method of filling the template pattern with the resist in a short time is desired.

### BRIEF DESCRIPTION OF THE DRAWINGS

FIG. 1 is a diagram illustrating a configuration of an imprint apparatus according to an embodiment;

FIG. 2 is a block diagram illustrating a configuration of a dropping position setting apparatus;

FIG. 3 is a flowchart illustrating a setting process procedure of resist dropping positions;

FIG. 4A to FIG. 4C are diagrams for explaining examples of a large pattern region;

FIG. 5 is a diagram for explaining a setting process of resist dropping positions;

FIG. 6A to FIG. 6C are diagrams illustrating setting examples of resist dropping positions;

FIG. 7A and FIG. 7B are diagrams illustrating the relationship between the perimeter of a large pattern region and the settable range;

FIG. 8 is a flowchart illustrating a process procedure of an imprinting process; and

FIG. 9 is a diagram illustrating a hardware configuration of the dropping position setting apparatus.

### DETAILED DESCRIPTION

In general, according to one embodiment, a non-transitory computer readable recording medium that records a dropping position setting program is provided. The dropping position setting program is a program that causes a computer to set a dropping position of resist to be dropped in an imprint shot on a processing target substrate. The dropping position setting program causes the computer to execute extracting a large pattern region whose pattern size is larger than a preset reference value from a template pattern on a basis of design layout data on the template pattern formed on a template used for imprinting. Moreover, the dropping position setting program causes the computer to execute setting a first dropping position within a predetermined range from a position of the large pattern region as a dropping position of resist to be dropped in an imprint shot on a processing target substrate. Moreover, the dropping position setting program causes the computer to execute setting a second dropping position in a region other than the first dropping position as the dropping position of resist.

A recording medium, an imprint method, and an imprint apparatus according to the embodiment will be explained below in detail with reference to the accompanying drawings. The present invention is not limited to this embodiment.

### Embodiment

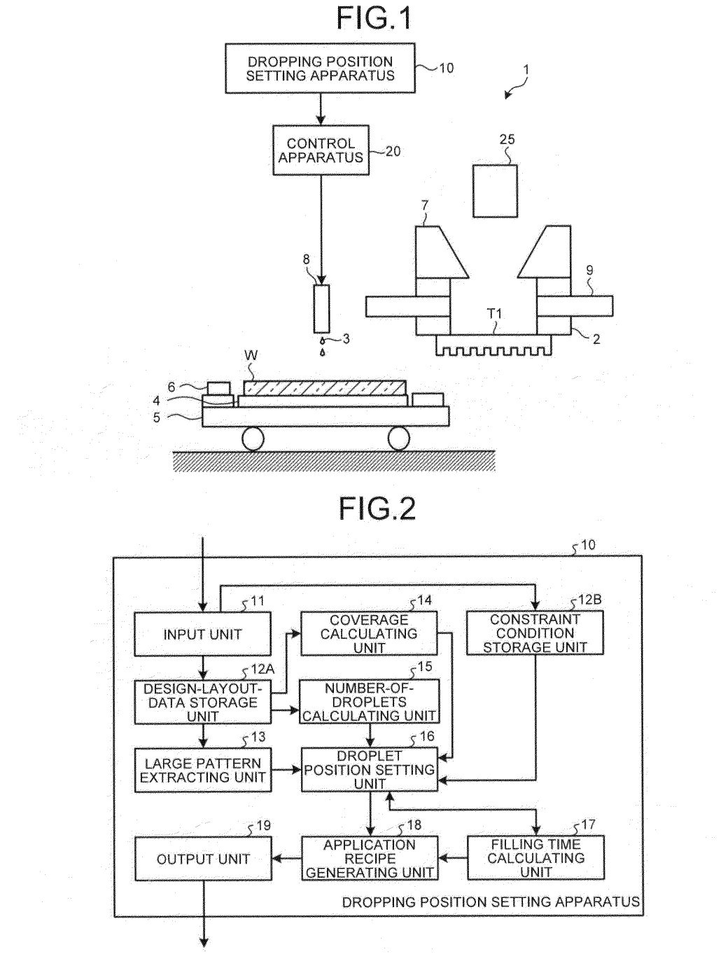

FIG. 1 is a diagram illustrating a configuration of an imprint apparatus according to the embodiment. An imprint apparatus 1 is an apparatus that performs imprint lithography, such as nanoimprint lithography (NIL), by an imprint method (for example, photo nanoimprint method). The imprint apparatus 1 forms a resist pattern on a transfer target substrate (processing target substrate), such as a wafer W, by using a template (mold of a master) that is a mold substrate.

The imprint apparatus 1 in the present embodiment sets a dropping position of a resist (photocurable organic material) 3 to be dropped onto the wafer W on the basis of a pattern layout (size, shape, coverage, and the like of a pattern) of a template pattern.

The imprint apparatus 1 drops the resist 3 onto the set dropping position and transfers a template pattern (such as a circuit pattern) onto the wafer W by using a template T1 on which a circuit pattern and the like are formed.

The imprint apparatus 1 includes a master stage 2, a substrate chuck 4, a sample stage 5, a reference mark 6, an alignment sensor 7, a droplet dropping apparatus 8, a stage base 9, a UV light source 25, a control apparatus 20, and a dropping position setting apparatus 10.

The wafer W is placed on the sample stage 5 and the sample stage 5 moves in a plane (in a horizontal plane) parallel to the placed wafer W. The sample stage 5 moves the wafer W to the lower side of the droplet dropping apparatus 8 when dropping the resist 3 onto the wafer W and moves the wafer W to the lower side of the template T1 when performing an imprinting process on the wafer W.

Moreover, the substrate chuck 4 is provided above the sample stage 5. The substrate chuck 4 fixes the wafer W at a predetermined position on the sample stage 5. Moreover, the reference mark 6 is provided above the sample stage 5. The reference mark 6 is a mark for detecting the position of the sample stage 5 and is used for alignment when loading the wafer W onto the sample stage 5.

The master stage 2 is provided on the bottom surface side (the wafer W side) of the stage base 9. The master stage 2 fixes the template T1 at a predetermined position by vacuum suction or the like from the back surface side (side on which a template pattern is not formed) of the template T1.

The stage base 9 supports the template T1 by the master stage 2 and presses a template pattern of the template T1 against the resist 3 on the wafer W. The stage base 9 performs pressing of the template T1 against the resist 3 and separation (releasing) of the template T1 from the resist 3 by moving in the up-and-down direction (vertical direction).

The resist 3 used in imprinting is photocurable resin, such as UV (Ultra-Violet-rays) curable resin. The resist 3 may be resin having other properties such as a thermosetting property. The alignment sensor 7 is provided above the stage base 9. The alignment sensor 7 is a sensor that detects the position of the wafer W and the position of the template T1.

The droplet dropping apparatus 8 is an apparatus that drops the resist 3 onto the wafer W by an inkjet method. The inkjet head (not shown) included in the droplet dropping apparatus 8 has a plurality of fine holes from which droplets of the resist 3 are ejected. The resist 3 of the same amount is ejected from each fine hole. Therefore, the resist 3 of the same amount is dropped onto the dropping position of the resist 3. The droplet dropping apparatus 8 drops the resist 3 onto a predetermined dropping position on the wafer W in accordance with an instruction from the control apparatus 20.

The UV light source 25 is a light source that emits UV light and is provided above the stage base 9. The UV light source 25 emits UV light from above the template T1 in a state where the template T1 that is a transparent member is pressed against the resist 3.

The control apparatus 20 is connected (connection other than the connection to the droplet dropping apparatus 8 is not shown) to each component of the imprint apparatus 1 and controls each component. The control apparatus 20 in the present embodiment instructs the droplet dropping apparatus 8 on the timing to eject the resist 3 on the basis of the dropping position of the resist 3 set by the dropping position setting apparatus 10.

Next, the configuration of the dropping position setting apparatus 10 will be explained. FIG. 2 is a block diagram illustrating a configuration of the dropping position setting apparatus. The dropping position setting apparatus 10 includes an input unit 11, a design-layout-data storage unit 12A, a constraint condition storage unit 12B, a large pattern extracting unit 13, a coverage calculating unit 14, a number-of-droplets calculating unit 15, a droplet position setting unit 16, a filling time calculating unit 17, an application recipe generating unit 18, and an output unit 19.

The input unit 11 inputs design layout data on a template pattern formed on the template T1 and sends it to the design-layout-data storage unit 12A. The design layout data on a template pattern is GDS data or the like. Moreover, the input unit 11 inputs constraint conditions of the dropping position of the resist 3 and sends it to the constraint condition storage unit 12B.

The design-layout-data storage unit 12A is, for example, a memory that stores the design layout data sent from the input unit 11. The constraint condition storage unit 12B is, for example, a memory that stores the constraint conditions sent from the input unit 11.

The large pattern extracting unit 13 extracts the position, size, and shape of a large pattern region from the design layout data in the design-layout-data storage unit 12A as large pattern information. A large pattern region is a pattern having a large pattern size or a pattern having a small pattern perimeter (edge length), and is a pattern that requires a long time for filling with the resist 3. The large pattern extracting unit 13 extracts a large pattern region that satisfies a preset reference (size and shape). The large pattern extracting unit 13 sends the extracted large pattern information to the droplet position setting unit 16.

The coverage calculating unit 14 calculates a pattern coverage distribution (pattern density distribution) in an imprint shot by using the design layout data in the design-layout-data storage unit 12A. The coverage calculating unit 14 sends the calculated pattern coverage distribution to the droplet position setting unit 16.

The number-of-droplets calculating unit 15 calculates the number of droplets (total number of necessary droplets) in ink jetting of the resist 3 to be dropped in an imprint shot on the basis of the design layout data in the design-layout-data storage unit 12A. The number of droplets (total number of resist droplets) of the resist 3 is determined based on the volume of the resist 3 calculated from the area of a template pattern in an imprint shot and the height of a resist pattern. Therefore, the number-of-droplets calculating unit 15 calculates the area of a template pattern in an imprint shot using the design layout data and calculates the total number of resist droplets using the area of the template pattern. The number-of-droplets calculating unit 15 sends the calculated total number of resist droplets to the droplet position setting unit 16.

The number-of-droplets calculating unit 15 may calculate the total number of resist droplets to be dropped in an imprint shot using the design layout data in the design-layout-data storage unit 12A and the pattern coverage distribution sent from the coverage calculating unit 14.

The droplet position setting unit 16 sets the dropping position (resist dropping position) of the resist 3 on the basis of the large pattern information extracted by the large pattern extracting unit 13, the total number of resist droplets calculated by the number-of-droplets calculating unit 15, the pattern coverage distribution calculated by the coverage calculating unit 14, and the constraint conditions in the constraint condition storage unit 12B. The resist dropping position is the arrangement position of the resist 3 in an imprint shot.

The droplet position setting unit 16 in the present embodiment sets the resist dropping positions (first dropping positions) for a large pattern region near large pattern regions in an imprint shot on the basis of the large pattern information and the constraint conditions. The droplet position setting unit 16, for example, sets the dropping position to the position according to the pattern size or the perimeter of a large pattern region.

Moreover, the droplet position setting unit 16 calculates the number of remaining resist droplets by subtracting the number of droplets of the resist 3 set near large pattern regions from the total number of resist droplets. The droplet position setting unit 16 sets the remaining resist dropping positions in an imprint shot for the number of remaining resist droplets. The droplet position setting unit 16 sets the remaining resist dropping positions (second dropping positions) in an imprint shot on the basis of the pattern coverage distribution and the constraint conditions.

The droplet position setting unit 16 sends the set resist dropping positions (resist dropping positions for a large pattern region and remaining resist dropping positions) to the filling time calculating unit 17. Moreover, when the droplet position setting unit 16 receives a notification (pass notification) indicating that the filling time is within a predetermined time from the filling time calculating unit 17, the droplet position setting unit 16 sends the set resist dropping positions to the application recipe generating unit 18.

The filling time calculating unit 17 calculates the filling time for filling a template pattern with the resist 3 when the resist 3 is dropped onto the resist dropping positions set by the droplet position setting unit 16 through simulation. If the calculated filling time is within the predetermined time, the filling time calculating unit 17 sends a notification indicating that the filling time is within the predetermined time to the application recipe generating unit 18.

When the application recipe generating unit 18 receives the resist dropping positions from the droplet position setting unit 16, the application recipe generating unit 18 generates an application recipe of the resist 3 by using the resist dropping positions. The application recipe generated by the application recipe generating unit 18 includes the timing to eject the resist 3 and the like. The application recipe generating unit 18 sends the generated application recipe to the output unit 19.

The output unit 19 sends the application recipe to the control apparatus 20. The control apparatus 20 controls the droplet dropping apparatus 8 by using the application recipe generated by the dropping position setting apparatus 10. The control apparatus 20 controls the droplet dropping apparatus 8 so that the resist 3 is dropped onto the resist dropping positions set in the application recipe.

In the present embodiment, the dropping position setting apparatus 10 is configured to include the filling time calculating unit 17, however, the dropping position setting apparatus 10 and the filling time calculating unit 17 may be configured separately. Moreover, in the present embodiment, the dropping position setting apparatus 10 is configured to include the application recipe generating unit 18, however, the dropping position setting apparatus 10 and the application recipe generating unit 18 may be configured separately.

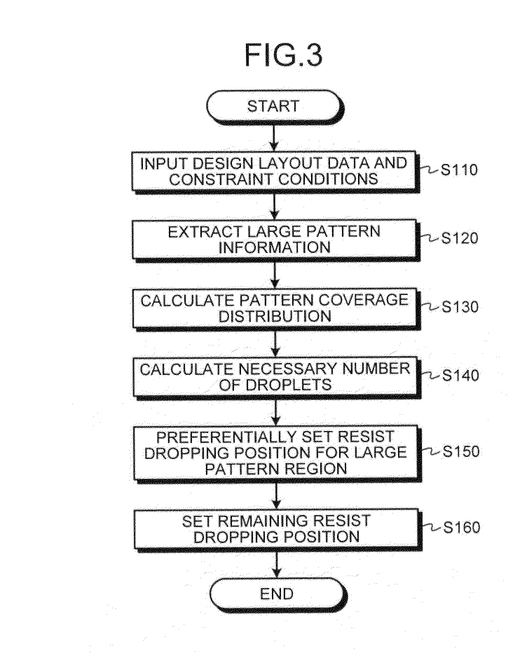

Next, the setting process procedure of the resist dropping positions will be explained. FIG. 3 is a flowchart illustrating the setting process procedure of the resist dropping positions. The design layout data on a template pattern and the constraint conditions are input to the input unit 11 of the dropping position setting apparatus 10 (Step S110). The input unit 11 sends the design layout data to the design-layout-data storage unit 12A and sends the constraint conditions to the constraint condition storage unit 12B.

The large pattern extracting unit 13 extracts the position, size, and shape of a large pattern region from the design layout data as the large pattern information (Step S120). Specifically, the large pattern extracting unit 13 extracts the position, size, and shape of a large pattern region whose pattern size is larger than a preset reference value from a template pattern as the large pattern information. The pattern size in the present embodiment is calculated using the pattern area and the pattern perimeter. The pattern size is, for example, a value obtained by dividing the pattern area by the pattern perimeter. In other words, the pattern size is calculated by (pattern size)=(pattern area)/(pattern perimeter). The large pattern extracting unit 13 sends the extracted large pattern information to the droplet position setting unit 16.

A large pattern region is not limited to the whole of one pattern and may be part of one pattern. In other words, it is possible to calculate the pattern size of each pattern obtained by dividing one pattern into a plurality of patterns as a separate pattern without being limited to the case of calculating the pattern size of one pattern.

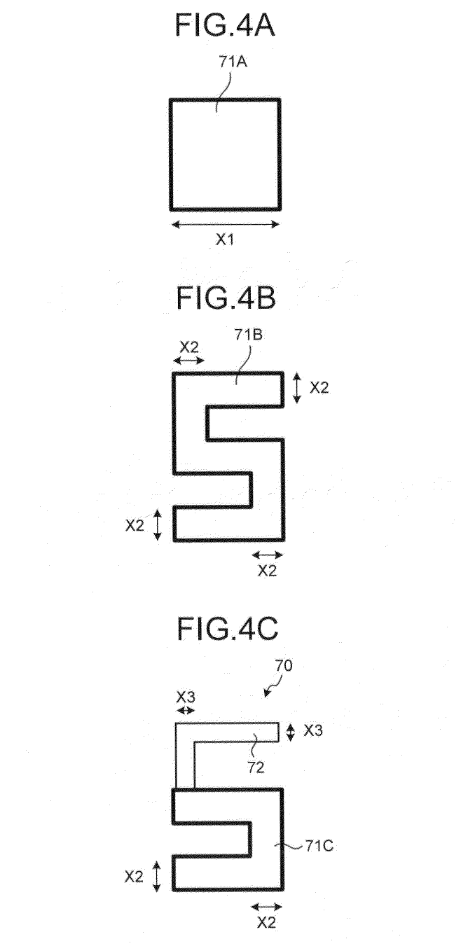

FIG. 4A to FIG. 4C are diagrams for explaining examples of a large pattern region. FIG. 4A to FIG. 4C illustrate top views of large pattern regions 71A to 71C. The large pattern region 71A is a pattern having a square region with a side length of X1. The large pattern region 71B is a pattern having an S-shaped region and the pattern width of the S-shape region is X2. These regions each have a pattern size (=pattern area/pattern perimeter) larger than the reference value as the whole of a pattern.

On the other hand, the large pattern region 71C is a pattern of part of a pattern 70 having an S-shaped region. The S-shaped pattern 70 as a whole is composed of an L-shaped pattern 72 having an L-shaped region with a pattern width of X3 and the large pattern region 71C having a C-shaped region with a pattern width of X2. In such a case, the large pattern extracting unit 13 divides the pattern 70 into a portion (the large pattern region 71C) with a pattern width of X2 and a portion (the L-shaped pattern 72) with a pattern width of X3. Then, the large pattern extracting unit 13 calculates the pattern size of each portion and extracts the C-shaped region having a pattern size larger than the set reference value as the large pattern region 71C. Moreover, the large pattern extracting unit 13 does not set a portion (the L-shaped pattern 72) whose pattern size is smaller than the set reference value as an extraction target. In other words, the large pattern extracting unit 13 extracts a large pattern region from a template pattern on the basis of the pattern area, the pattern perimeter, and the pattern width.

In this manner, the L-shaped pattern 72 and the large pattern region 71C forming one pattern 70 may be treated as separate pattern regions and the pattern size may be calculated for each pattern region and compared with a reference value.

For example, in some cases, the design layout data includes a pattern having a shape in which portions with different pattern widths are connected, as in the case where a pad is withdrawn from a line pattern of the wiring. For such a pattern, the pattern size may be compared with the reference value for each of the pattern regions having pattern widths different from each other without calculating the pattern size of the whole of the connected pattern. Consequently, a pattern that satisfies the reference for a large pattern region as part of the region is extracted even if the reference for a large pattern region is not satisfied as the whole of the pattern.

Moreover, the coverage calculating unit 14 calculates the pattern coverage distribution in an imprint shot by using the design layout data (Step S130). The coverage calculating unit 14 sends the calculated pattern coverage distribution to the droplet position setting unit 16.

The number-of-droplets calculating unit 15 calculates the necessary number of droplets (total number of resist droplets) of the resist 3 in an imprint shot on the basis of the design layout data (Step S140). The number-of-droplets calculating unit 15 sends the calculated total number of resist droplets to the droplet position setting unit 16.

The droplet position setting unit 16 sets the resist dropping positions on the basis of the large pattern information, the total number of resist droplets, the pattern coverage distribution, and the constraint conditions. Specifically, the droplet position setting unit 16 preferentially sets the resist dropping positions for a large pattern region near large pattern regions on the basis of the large pattern information and the constraint conditions (Step S150).

Moreover, the droplet position setting unit 16 calculates the number of remaining resist droplets by subtracting the number of droplets of the resist 3 set near the large pattern regions from the total number of resist droplets. The droplet position setting unit 16 sets the remaining resist dropping positions in other regions (regions other than the resist dropping positions for a large pattern region) for the number of remaining resist droplets (Step S160). At this time, the droplet position setting unit 16 sets the remaining resist dropping positions in an imprint shot on the basis of the pattern coverage distribution and the constraint conditions.

The droplet position setting unit 16 sends the set resist dropping positions (resist dropping positions for a large pattern region and remaining resist dropping positions) to the filling time calculating unit 17. The filling time calculating unit 17 calculates the filling time for filling a template pattern with the resist 3 when the resist 3 is dropped onto the resist dropping positions through simulation. The filling time calculating unit 17 in this embodiment calculates the filling time by using the design layout data and the resist dropping positions.

When the calculated filling time is out of the allowable range (longer than a predetermined time), the filling time calculating unit 17 sends the positions (failed coordinates) in an imprint shot, at which the filling time is out of the allowable range, to the droplet position setting unit 16. In this case, the droplet position setting unit 16 repeats the processes in Step S150 and Step S160. Specifically, the droplet position setting unit 16 sets the resist dropping positions for a large pattern region and the remaining resist dropping positions on the basis of the failed coordinates, the large pattern information, the total number of resist droplets, the pattern coverage distribution, and the constraint conditions.

The droplet position setting unit 16 and the filling time calculating unit 17 repeat the setting process of the dropping positions and the calculating process of the filling time until the filling time falls within the allowable range. When the calculated filling time is within the allowable range (within the predetermined time), the filling time calculating unit 17 notifies the droplet position setting unit 16 of the fact that the filling time is within the allowable range. Consequently, the droplet position setting unit 16 sends the set resist dropping positions to the application recipe generating unit 18.

The process in Step S120 may be performed after the process in Step S130 or the process in Step S140. Moreover, the process in Step S130 may be performed after the process in Step S140 or the process in Step S150. Moreover, the process in Step S140 may be performed after the process in Step S150.

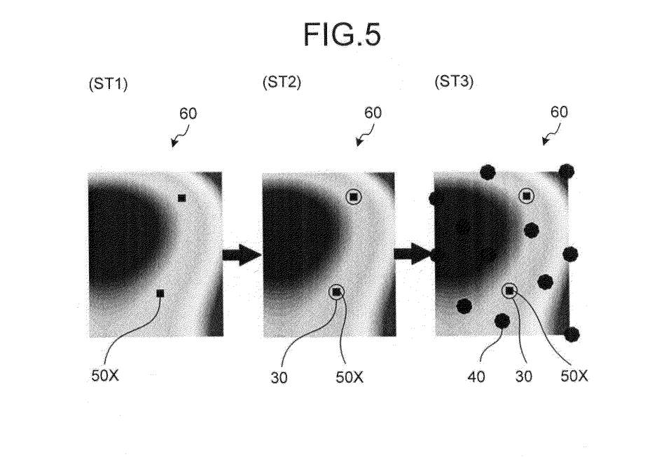

The setting process of the resist dropping positions will be explained. FIG. 5 is a diagram for explaining the setting process of the resist dropping positions. FIG. 5 illustrates a coverage distribution map 60 illustrating the pattern coverage distribution. In the coverage distribution map 60, a dark shaded region indicates a region in which the pattern coverage is high (density is high) and a light shaded region indicates a region in which the pattern coverage is low (density is low).

Even if the pattern coverage is low, a long time is required for filling with the resist 3 in a large pattern region. Therefore, in the present embodiment, the large pattern extracting unit 13 extracts in advance the position, size, and shape (perimeter) of a large pattern region 50X as the large pattern information. The large pattern extracting unit 13 determines whether each pattern is the large pattern region 50X on the basis of whether the pattern size is larger than a predetermined value (ST1). Then, the droplet position setting unit 16 sets a resist dropping position 30 that is the resist dropping position for the large pattern region 50X near the large pattern region 50X on the basis of the large pattern information and the constraint conditions (ST2). The droplet position setting unit 16 in this embodiment sets the resist dropping position 30 to satisfy the constraint conditions. The constraint conditions, for example, include information indicating the relationship between a pattern arrangement near the large pattern region 50X and the settable resist dropping position 30 (setting range). The constraint conditions define the range (range of the settable resist dropping position 30) of the resist dropping position 30 in which the resist filling time in the large pattern region 50X can be made within a predetermined time. The constraint conditions are, for example, generated based on the size and shape of the large pattern region 50X.

For example, in the constraint conditions, constraints are provided for setting the resist dropping position 30 to the same position as the large pattern region 50X when another pattern is not arranged within a predetermined range from the large pattern region 50X.

After the droplet position setting unit 16 sets the resist dropping position 30 for all the large pattern regions 50X, the droplet position setting unit 16 sets remaining resist dropping positions 40 on the basis of the pattern coverage distribution and the constraint conditions (ST3). In the constraint conditions that the droplet position setting unit 16 in this embodiment refers to, the distance settable as a distance between the resist dropping positions 40, and the like are set.

The constraint conditions will be explained. In the constraint conditions, for example, the distance (settable range) from the large pattern region 50X settable as the resist dropping position 30 is defined. The settable range is defined for each size and shape of the large pattern region 50X. In other words, the constraint conditions are generated such that when the pattern size of the large pattern region 50X and the shape of the large pattern region 50X are determined, the settable range according to the size and shape of the large pattern region 50X is determined. When generating the constraint conditions, the settable range is defined so that the resist filling time falls within a predetermined time on the basis of the relationship between the resist dropping position 30 and the resist filling time in the large pattern region 50X. Next, specific examples of the constraint conditions will be explained. Predetermined ranges=A1 to A3, settable ranges=D1 to D3, and the like explained below are not shown.

### Example 1

In the constraint conditions, for example, the settable range (distance from the large pattern region 50X settable as the resist dropping position 30)=0 is defined as the constraints on the resist dropping position when another pattern is not arranged in a predetermined range =A1 from the large pattern region 50X. In this case, the resist dropping position 30 is set to the same position as the large pattern region 50X.

### Example 2

Moreover, in the constraint conditions, for example, the settable range =D1 is defined as the constraints on the resist dropping position when a pattern other than the large pattern region 50X is arranged in a predetermined range =A1 from the large pattern region 50X. In this case, the resist dropping position 30 is set within a range in which the distance from the large pattern region 50X is D1. The settable range =D1 is defined, for example, for each pattern coverage in the predetermined range =A1 from the large pattern region 50X and for each predetermined range =A1.

### Example 3

Moreover, in the constraint conditions, for example, the settable range =D2 is defined as the constraints on the resist dropping position when the second large pattern region 50X is arranged in a predetermined range =A2 from the first large pattern region 50X. In this case, the resist dropping position 30 is set so that the distance from both the first and second large pattern regions 50X is within D2. The settable range =D2 is defined, for example, for each size and each shape of the first large pattern region 50X, each size and each shape of the second large pattern region 50X, and each predetermined range =A2.

### Example 4

Moreover, in the constraint conditions, for example, the settable range =D3 from the first large pattern region 50X and the settable number N1 of the resist dropping positions 30 are defined as the constraints on the resist dropping position when a plurality of the second large pattern regions 50X is arranged in a predetermined range =A3 from the first large pattern region 50X. For example, when the settable number N1 of the resist dropping positions 30 is two, up to two resist dropping positions 30 are set in the settable range =D3 from the first large pattern region 50X. The settable range =D3 from the first large pattern region 50X and the settable number N1 are defined, for example, for each size and each shape of the first large pattern region 50X, each size and each shape of the second large pattern region 50X, and each predetermined range =A3.

### Example 5

Moreover, in the constraint conditions, for example, the distance settable as a distance between the resist dropping positions 40, the distance settable as a distance between the resist dropping positions 30, the distance settable as a distance between the resist dropping positions 30 and 40, and the like are defined.

### Example 6

When a predetermined number M or more of the large pattern regions 50X are arranged in a predetermined range =A3, the resist dropping position 30 may be set for each large pattern region. In the constraint conditions in this case, the predetermined range =A3, the predetermined number M, the settable number N2 of the resist dropping positions 30, and the like are defined. Moreover, the settable number N2 may be determined based on the total number of resist droplets and the size of a large pattern region group. In the constraint conditions in this case, the settable number N3 with respect to the combination of the total number of resist droplets and the size of a large pattern region group is defined.

The constraint conditions may be prioritized. In this case, the droplet position setting unit 16 sets the resist dropping position 30 and the resist dropping position 40 in such a way that the constraint conditions having a high priority are preferentially satisfied.

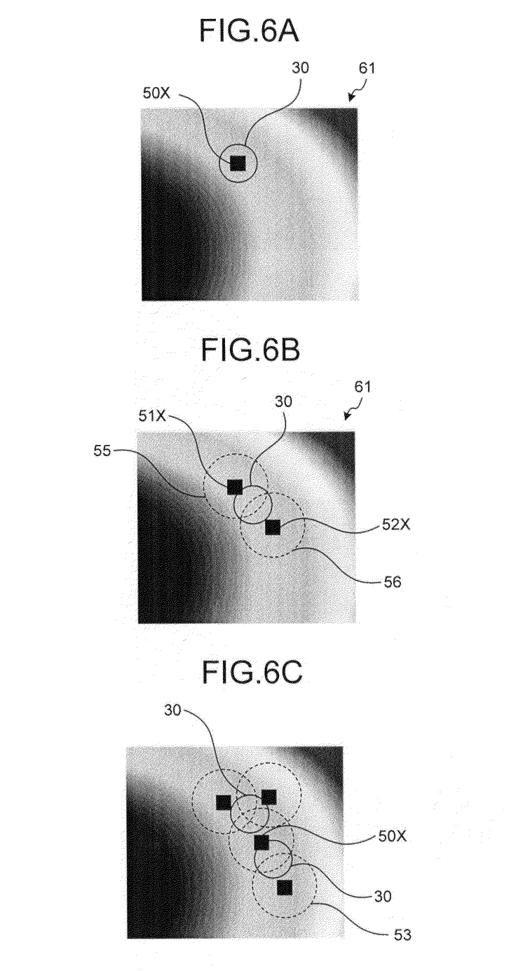

FIG. 6A to FIG. 6C are diagrams illustrating setting examples of the resist dropping positions. FIG. 6A to FIG. 6C illustrate setting examples of the resist dropping positions 30 for the large pattern region 50X. FIG. 6A to FIG. 6C illustrate a coverage distribution map 61 illustrating the pattern coverage distribution.

For example, as shown in FIG. 6A, when another pattern is not arranged within a predetermined range from the large pattern region 50X, the resist dropping position 30 is set to substantially the same position as the large pattern region 50X. In other words, when the large pattern region 50X is present completely in isolation, the resist dropping position 30 is set near the large pattern region 50X.

Moreover, as shown in FIG. 6B, when a second large pattern region 52X is arranged within a predetermined range from a first large pattern region 51X, settable ranges 55 and 56 for the first and second large pattern regions 51X and 52X are set based on the constraint conditions. Then, the resist dropping position 30 is set in a region in which the settable ranges 55 and 56 overlap with each other. In other words, when the first and second large pattern regions 51X and 52X are arranged adjacent to each other, at least one resist dropping position 30 is set in such a way that the distance from the first large pattern region 51X is within a predetermined range and the distance from the second large pattern region 52X is within a predetermined range.

Moreover, as shown in FIG. 6C, when settable ranges 53 settable for the large pattern regions 50X overlap with each other, at least one resist dropping position 30 is set in each settable range 53. In this case, a plurality of the resist dropping positions 30 may be set in one settable range 53. Moreover, one resist dropping position 30 may be set to a position at which three or more settable ranges 53 overlap with each other.

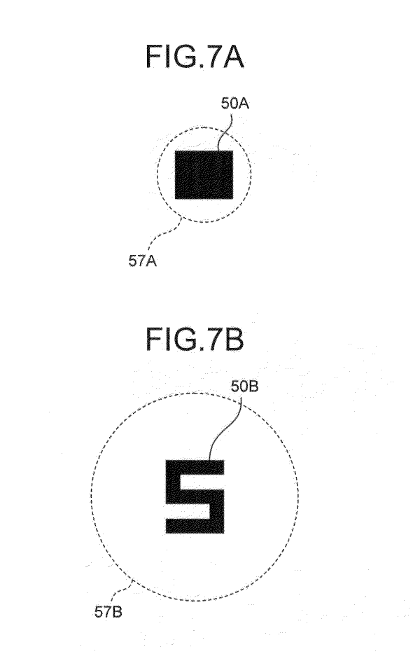

FIG. 7A and FIG. 7B are diagrams illustrating the relationship between the perimeter of a large pattern region and the settable range. A large pattern region 50A shown in FIG. 7A and a large pattern region 50B shown in FIG. 7B have the same pattern size. The large pattern region 50B has a longer perimeter than the large pattern region 50A. In such a case, if the distance from the large pattern region 50A to the resist dropping position 30 is the same as the distance from the large pattern region 50B to the resist dropping position 30, the filling rate of the resist 3 in the large pattern region 50A becomes lower than that in the large pattern region 50B.

Thus, in the present embodiment, the settable range is set narrower for a large pattern region having a shorter perimeter. For example, a settable range 57A narrower than a settable range 57B of the large pattern region 50B having a longer perimeter is set for the large pattern region 50A having a shorter perimeter. Consequently, the settable range 57A having a narrow range is set for the large pattern region 50A having a short perimeter, therefore, the filling time of the resist 3 can be prevented from becoming long.

In this manner, the droplet position setting unit 16 sets the resist dropping positions 30 and 40 on the basis of the large pattern information, the total number of resist droplets, the pattern coverage distribution, and the constraint conditions. Then, the application recipe generating unit 18 generates the application recipe of the resist 3 by using the resist dropping positions set by the droplet position setting unit 16.

The application recipe generating unit 18 sends the generated application recipe to the output unit 19. The output unit 19 sends the application recipe to the control apparatus 20. The control apparatus 20 controls the droplet dropping apparatus 8 by using the application recipe generated by the dropping position setting apparatus 10.

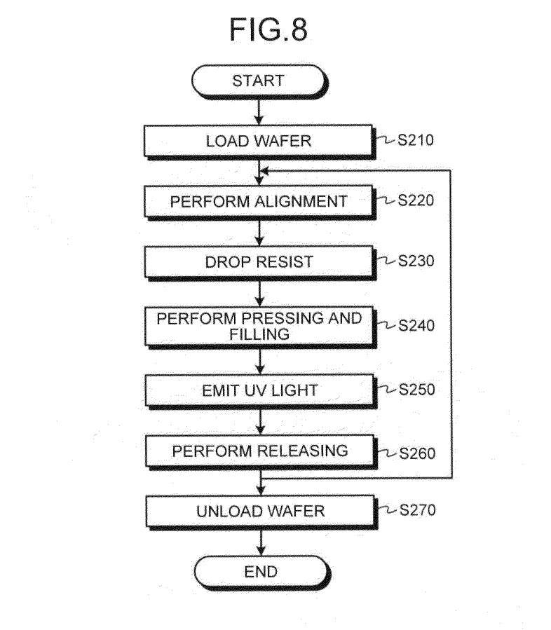

The process procedure of the imprinting process will be explained. FIG. 8 is a flowchart illustrating the process procedure of the imprinting process. The imprint apparatus 1 loads the wafer W (Step S210) and places the wafer W on the sample stage 5. Then, the imprint apparatus 1 performs alignment of the wafer W by using the reference mark 6 and the alignment sensor 7 (Step S220).

The control apparatus 20 controls the droplet dropping apparatus 8 by using the application recipe generated by the dropping position setting apparatus 10. Consequently, the droplet dropping apparatus 8 drops the resist 3 onto the positions on the wafer W defined by the application recipe (Step S230).

Thereafter, the imprint apparatus 1 presses (imprints) the template T1 against the resist 3, whereby filling of a template pattern with the resist 3 is performed (Step S240). When the template T1 formed by engraving the template pattern is brought into contact with the resist 3, the resist 3 flows into the template pattern by capillary action. Then, when filling of the template pattern with the resist 3 is completed, the UV light source 25 emits UV light from above the template T1 (Step S250).

Then, when the resist 3 is cured, the imprint apparatus 1 releases the template T1 from the resist 3 (Step S260). Consequently, a resist pattern having the inverse shape of the template pattern is formed on the wafer W. Thereafter, the imprint apparatus 1 unloads the wafer W (Step S270).

The setting process of the resist dropping positions and the imprinting process by using the imprint apparatus 1 are performed, for example, for each layer of a wafer process. Specifically, the design layout data is generated for each resist pattern to be formed on the wafer W and a template pattern in accordance with each design layout data is generated. Then, the template T1 having the template pattern is formed.

The dropping position setting apparatus 10 performs the setting process of the resist dropping positions and the generating process of the application recipe for each design layout data. Then, the control apparatus 20 causes the resist 3 to be dropped onto the wafer W by using the application recipe corresponding to a template pattern used for imprinting. Moreover, the control apparatus 20 causes a resist pattern to be formed on the wafer W by using the template T1. The lower layer side of the wafer W is processed (for example, etched) with this resist pattern as a mask. When manufacturing a semiconductor device, the setting process of the resist dropping positions, the generating process of the application recipe, the imprinting process, the processing process for a processing target, and the like are repeated for each layer in the wafer process.

Next, the hardware configuration of the dropping position setting apparatus 10 will be explained. In this embodiment, the hardware configuration of the dropping position setting apparatus 10 in the case where the filling time calculating unit 17 and the application recipe generating unit 18 are configured separately from the dropping position setting apparatus 10 will be explained.

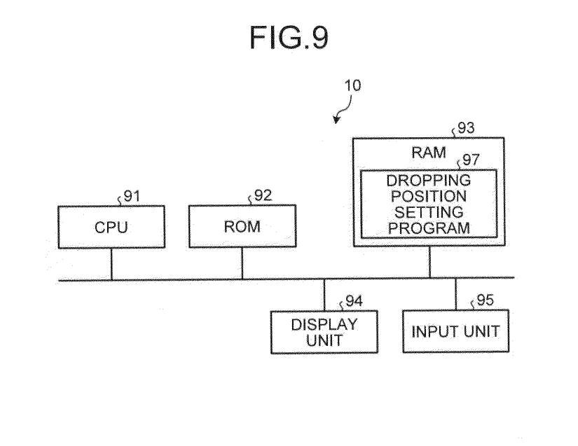

FIG. 9 is a diagram illustrating a hardware configuration of the dropping position setting apparatus. The dropping position setting apparatus 10 includes a CPU (Central Processing Unit) 91, a ROM (Read Only Memory) 92, a RAM (Random Access Memory) 93, a display unit 94, and an input unit 95. In the dropping position setting apparatus 10, the CPU 91, the ROM 92, the RAM 93, the display unit 94, and the input unit 95 are connected via a bus line.

The CPU 91 sets the resist dropping positions by using a dropping position setting program 97 that is a computer program. The dropping position setting program 97 is a computer program product that is executable in a computer and includes a computer readable recording medium including instructions for setting the dropping positions. In the dropping position setting program 97, the instructions cause the computer to execute the setting process of the dropping positions.

The display unit 94 is a display apparatus, such as a liquid crystal monitor, and displays a design layout of a template pattern, constraint conditions, the large pattern region 50X, the pattern coverage distribution, the total number of resist droplets, the resist dropping positions, and the like on the basis of an instruction from the CPU 91. The input unit 95 includes a mouse and a keyboard, and inputs instruction information (such as parameter necessary for setting the resist dropping positions) that is externally input by a user. The instruction information input to the input unit 95 is sent to the CPU 91.

The dropping position setting program 97 is stored in the ROM 92 and is loaded in the RAM 93 via the bus line. FIG. 9 illustrates a state where the dropping position setting program 97 is loaded in the RAM 93.

The CPU 91 executes the dropping position setting program 97 loaded in the RAM 93. Specifically, in the dropping position setting apparatus 10, the CPU 91 reads the dropping position setting program 97 from the ROM 92, loads it in a program storage area in the RAM 93, and executes various processes, in accordance with the input of an instruction by a user from the input unit 95. The CPU 91 temporarily stores various data generated in the various processes in a data storage area formed in the RAM 93.

The dropping position setting program 97 executed in the dropping position setting apparatus 10 has a module configuration including the large pattern extracting unit 13, the coverage calculating unit 14, the number-of-droplets calculating unit 15, and the droplet position setting unit 16, and these are loaded in a main storage device to be generated on the main storage device.

The time until the grooves (recess portions) of the template T1 are completely filled with the resist 3 depends on the interval between droplets of the resist 3 and the pattern size of a template pattern. When the interval between the droplets is large, if the template T1 is brought into proximity to the wafer W, a long time is required until the resist 3 is sufficiently spread between the droplets. Moreover, when a large pattern region and a small pattern region are formed in the template T1, although the small pattern region can be filled with the resist 3 in a short time, a long time is required to fill the large pattern region with the resist 3. In the present embodiment, because the resist dropping position 30 is preferentially set to a position near the large pattern region 50X, the large pattern region 50X can also be filled with the resist 3 in a short time. Therefore, the filling time for filling a template pattern with the resist 3 can be shortened and moreover, a filling failure defect in the large pattern region 50X can be prevented. Moreover, the resist 3 to be dropped to each resist dropping position is the same amount at each resist dropping position, therefore, the time required for dropping the resist 3 can be suppressed.

The large pattern extracting unit 13 may be configured so that the extraction condition of the large pattern region 50X by the large pattern extracting unit 13 can be changed in accordance with an instruction input from the input unit 11.

In this manner, according to the present embodiment, because the resist 3 is preferentially arranged near the large pattern region 50X, a template pattern can be filled with the resist 3 in a short time. Therefore, throughput in the imprinting process can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-transitory computer readable recording medium that records a dropping position setting program that causes a computer to set a dropping position of resist to be dropped in an imprint shot on a processing target substrate, the dropping position setting program causing the computer to execute:
extracting a large pattern region whose pattern size is larger than a preset reference value from a template pattern on a basis of design layout data on the template pattern formed on a template used for imprinting;
setting a first dropping position within a predetermined range from a position of the large pattern region as a dropping position of resist to be dropped in an imprint shot on a processing target substrate; and
setting a second dropping position in a region other than the first dropping position as the dropping position of resist.

2. The non-transitory computer readable recording medium according to claim 1, wherein
the dropping position setting program further causes the computer to execute calculating a pattern coverage distribution of the template pattern on a basis of the design layout data, and
the setting the second dropping position includes setting the second dropping position to a position according to the pattern coverage distribution.

3. The non-transitory computer readable recording medium according to claim 1, wherein the setting the first dropping position includes setting the first dropping position on a basis of constraint conditions defining a range of the first dropping position in which a resist filling time in the large pattern region is capable of being within a predetermined time.

4. The non-transitory computer readable recording medium according to claim 1, wherein the setting the first dropping position includes setting the first dropping position to a position according to a pattern size or a perimeter of the large pattern region.

5. The non-transitory computer readable recording medium according to claim 1, wherein the setting the first dropping position includes setting the first dropping position to substantially a same position as the large pattern region when another pattern is not arranged within a predetermined range from the large pattern region.

6. The non-transitory computer readable recording medium according to claim 1, wherein
the dropping position setting program further causes the computer to execute calculating total number of resists to be dropped in the imprint shot as total number of resist droplets on a basis of the design layout data, and
the setting the second dropping position includes setting the second dropping position for a number obtained by subtracting set number of first dropping positions from the total number of resist droplets.

7. An imprint method comprising:
extracting a large pattern region whose pattern size is larger than a preset reference value from a template pattern on a basis of design layout data on the template pattern formed on a template used for imprinting;
setting each of a first dropping position within a predetermined range from a position of the large pattern region and a second dropping position in a region other than the first dropping position as a dropping position of resist to be dropped in an imprint shot on a processing target substrate; and
performing an imprinting process by the template by dropping resist onto the first and second dropping positions on the processing target substrate.

8. The imprint method according to claim 7, further comprising calculating a pattern coverage distribution of the template pattern on a basis of the design layout data, wherein
the setting the second dropping position includes setting the second dropping position to a position according to the pattern coverage distribution.

9. The imprint method according to claim 7, wherein the setting the first dropping position includes setting the first dropping position on a basis of constraint conditions defining a range of the first dropping position in which a resist filling time in the large pattern region is capable of being within a predetermined time.

10. The imprint method according to claim 7, wherein the setting the first dropping position includes setting the first dropping position to a position according to a pattern size or a perimeter of the large pattern region.

11. The imprint method according to claim 7, wherein the setting the first dropping position includes setting the first dropping position to substantially a same position as the large pattern region when another pattern is not arranged within a predetermined range from the large pattern region.

12. The imprint method according to claim 7, further comprising calculating total number of resists to be dropped in the imprint shot as total number of resist droplets on a basis of the design layout data, wherein
the setting the second dropping position includes setting the second dropping position for a number obtained by subtracting set number of first dropping positions from the total number of resist droplets.

13. The imprint method according to claim 7, further comprising:
calculating a resist filling time in the template pattern when the imprinting process by the template is performed by dropping resist onto the first and second dropping positions on the processing target substrate;
extracting a failed position at which a resist filling time fails in the imprint shot on a basis of the resist filling time; and
resetting each of the first dropping position and the second dropping position on a basis of the failed position.

14. The imprint method according to claim 13, further comprising generating a resist application recipe that causes the resist to be dropped onto the first and second dropping positions when the resist filling time passes at all positions in the imprint shot.

15. An imprint apparatus comprising:
a dropping apparatus that drops resist in an imprint shot on a processing target substrate;
a dropping position setting apparatus that extracts a large pattern region whose pattern size is larger than a preset reference value from a template pattern on a basis of design layout data on the template pattern formed on a template used for imprinting and sets a first dropping position within a predetermined range from a position of the large pattern region as a dropping position of resist on the processing target substrate and a second dropping position in a region other than the first dropping position as the dropping position of resist; and
a control apparatus that controls the dropping apparatus so that resist is dropped onto the first and second dropping positions on the processing target substrate.

16. The imprint apparatus according to claim 15, wherein the dropping position setting apparatus further calculates a pattern coverage distribution of the template pattern on a basis of the design layout data, and, when setting the second dropping position, sets the second dropping position to a position according to the pattern coverage distribution.

17. The imprint apparatus according to claim 15, wherein the dropping position setting apparatus, when setting the first dropping position, sets the first dropping position on a basis of constraint conditions defining a range of the first dropping position in which a resist filling time in the large pattern region is capable of being within a predetermined time.

18. The imprint apparatus according to claim 15, wherein the dropping position setting apparatus, when setting the first dropping position, sets the first dropping position to a position according to a pattern size or a perimeter of the large pattern region.

19. The imprint apparatus according to claim 15, wherein
the dropping position setting apparatus further calculates total number of resists to be dropped in the imprint shot as total number of resist droplets on a basis of the design layout data, and, when setting the second dropping position, sets the second dropping position for a number obtained by subtracting set number of first dropping positions from the total number of resist droplets.

20. The imprint apparatus according to claim 15, further comprising an application recipe generating apparatus that generates a resist application recipe that causes the resist to be dropped onto the first and second dropping positions.
